(19) United States
(12) Patent Application Publication
(10) Pub. No.: US 2022/0049340 A1
(43) Pub. Date: Feb. 17, 2022

(54) THERMAL SPRAYING METHOD AND APPARATUS FOR PRODUCING ENVIRONMENTAL BARRIER COATINGS

(71) Applicant: Rolls-Royce Corporation, Indianapolis, IN (US)

(72) Inventor: Li Li, Indianapolis, IN (US)

(21) Appl. No.: 17/400,791

(22) Filed: Aug. 12, 2021

Related U.S. Application Data
(60) Provisional application No. 63/065,148, filed on Aug. 13, 2020.

(51) Int. Cl. C23C 4/134; C23C 4/10

(52) U.S. Cl. CPC C23C 4/134; C23C 4/10

(57) ABSTRACT

A method includes feeding at least one ceramic feedstock into a heating zone of a thermal spray apparatus to form a heated ceramic feedstock. The heated ceramic feedstock is entrained in a plasma gas to form a heated gas stream directed toward a target surface of a CMC substrate. A sacrificial composition is fed with a sacrificial composition feed apparatus into the heated gas stream downstream of the heating zone at a selected injection angle α of about −30° to about +30° with respect to a plane of the target surface of the substrate. The heated ceramic feedstock is deposited from the heated gas stream onto the target surface to form a coating thereon. The thermal spray apparatus and the sacrificial composition feed system are configured to independently control a chemistry and a porosity of the coating.

This application claims the benefit of U.S. Provisional Application Ser. No. 63/065,148, entitled “THERMAL SPRAYING METHOD AND APPARATUS FOR PRODUCING ENVIRONMENTAL BARRIER COATINGS”, filed on Aug. 13, 2020, the entire content of which is incorporated herein by reference.

### BACKGROUND

High temperature components such as engines face increasing performance demands at higher temperatures. Under certain operating conditions, siliceous materials such as airborne dust, sand, fly ash, volcanic dust, concrete dust, and fuel residue ingested into a high temperature component may accumulate on certain hot surfaces, for example, on blade, vanes, combustion tiles and turbine segments. These materials may fuse and melt when exposed to high temperatures, for example, temperatures above 1240° C., depending on the composition of the deposited materials. Calcium-magnesium-alumino-silicate (CMAS), is the general name given to these molten deposits, as the predominant oxides are calcia (CaO), magnesia (MgO), alumina (Al₂O₃) and silica (SiO₂).

Turbine engine components may be coated with one or more barrier layers to provide protection against thermal flux, erosion, and/or environmental contamination, for example, by reducing or preventing CMAS formation, migration, or infiltration. In some examples, environmental barrier coatings (EBCs) may be used to protect Si-containing substrates such as SiC/SiC ceramic matrix composites (CMC) from water vapor attack. Rare earth (RE) silicates such as ytterbium disilicate (YbDS) and ytterbium monosilicate (YbMS) have been used in EBCs for SiC based CMCs. Among other desirable attributes, the RE silicates have a good match of coefficient-of-thermal-expansion (CTE) with CMC substrate materials.

### SUMMARY

EBC coatings can be formed with a wide variety of production methods including one or more of vapor deposition, slurry deposition, electrophoretic deposition, or thermal spraying. Suitable thermal spraying techniques for making EBC coatings can include, for example, air plasma spray, low pressure plasma spray, suspension plasma spray, or high-velocity oxy-fuel (HVOF) spraying.

In some of these production thermal spraying techniques, the RE silicate content of the EBC coatings can be adjusted by controlling parameters of the spray gun used to make the coatings, such as, for example, the flow rate of plasma gas, a carrier gas carrying the ceramic feedstock, the gun current creating a heating zone to heat the ceramic feedstock, and standoff distances between the spray gun and a target surface of a substrate. The RE silicate content of the EBC may also be controlled by varying the powder morphology and particle size of the ceramic feedstocks used in the thermal spray processes. However, improved EBC performance in a selected application can depend on precisely controlling both the RE silicate content and the microstructure of the thermally sprayed coating, and attempts to control both these parameters in a production process have proven to be difficult, time consuming, and inefficient.

In general, the present disclosure is directed to apparatus and production methods that can produce advanced EBCs with independently tunable RE silicate content and porosity. In some examples, the present disclosure is directed to a thermal spraying process in which a ceramic feedstock is fed into a heating zone, and the heated ceramic feedstock is transported toward a target surface of a substrate by a carrier gas in the form of a heated gas stream to form a coating on the target surface. Before the heated gas stream reaches the target surface, a sacrificial composition is fed into the heated gas stream between the heating zone and the target surface at a selected introduction angle. The sacrificial composition modifies in-flight behavior of the heated gas stream as the heated gas stream moves toward the target surface, which in turn modifies the properties of the coating formed by the heated gas stream on the target surface.

In some examples, which are not intended to be limiting, various process parameters of the sacrificial composition feed, such as feed composition and particle size, feed injection angle, feed rate, carrier gas flow rate and the like, can be controlled to provide a coating on the target surface with a wide range of microstructures. In some examples, the process parameters of the sacrificial composition feed can be controlled independently of the composition of the ceramic feedstock, which can enable continuous and precise independent control of both the chemical composition and the microstructure of the coating in a production setting.

In one example, which is not intended to be limiting, the apparatus and methods of the present disclosure can be used to cost-effectively produce abradable coatings with independent tunability of RE silicate phase content and porosity. In another example, the apparatus and methods of the present disclosure can be used to produce abradable coatings with discreet layers with graded RE silicate content and predetermined porosity. For example, the graded abradable coatings may include layers rich in RE monosilicate and layers rich in RE disilicate, each layer having an independently selectable porosity. These layered abradable coatings can maintain excellent CMAS and water vapor resistance while providing a good CTE match with the CMC substrate, which can lower thermal stress in the coatings and in in a CMC seal segment. Thus, in some examples, the abradable coatings may allow high-temperature CMC components to more safely operate in relatively higher temperature, steamy, or dusty environments, and may provide better coating strength, better resistance to oxidation, water vapor, and CMAS attack, or combinations thereof.

In one aspect, the present disclosure is directed to a method including feeding at least one ceramic feedstock into a heating zone of a thermal spray apparatus to form a heated ceramic feedstock; entraining the heated ceramic feedstock in a plasma gas to form a heated gas stream directed toward a target surface of a substrate, the substrate including a ceramic matrix composite (CMC); feeding a sacrificial composition with a sacrificial composition feed apparatus into the heated gas stream downstream of the heating zone, wherein the sacrificial composition is fed into the heated gas stream at a selected injection angle α of about −30° to about +30° with respect to a plane of the target surface of the substrate; and depositing the heated ceramic feedstock from the heated gas stream onto the target surface to form a coating thereon, wherein the thermal spray apparatus and the sacrificial composition feed system are configured to independently control a chemistry and a porosity of the coating.

In another aspect, the present disclosure is directed to a thermal spray apparatus. The thermal spray apparatus includes a spray gun with at least one injection port configured to feed a ceramic feedstock into a heating zone, wherein the ceramic feedstock is heated in the heating zone to form a heated ceramic feedstock. At least one plasma gas is supplied to entrain the heated ceramic feedstock and provide a heated gas stream downstream of the heating zone, wherein the heated gas stream is directed toward a target surface of a substrate. A sacrificial composition feed apparatus is between the heating zone of the spray gun and the target surface, wherein the sacrificial composition feed apparatus includes an adjustable nozzle configured to feed a sacrificial composition into the heated gas stream at an injection angle α of −30° to +30° with respect to a plane of the target surface of the substrate. The spray gun and the sacrificial composition feed apparatus are configured to provide independent control of a chemistry and a porosity of a coating formed on the target surface of the substrate.

In another aspect, the present disclosure is directed to a method for forming a coating on a target surface of a substrate including a ceramic matrix composite (CMC). The method includes entraining a heated ceramic feedstock in a plasma gas stream in a plasma spray gun to form a plasma flame directed toward the target surface, wherein the ceramic feedstock includes a rare earth (RE) silicate; feeding with a sacrificial composition injection apparatus a sacrificial polymeric composition into the plasma flame at an injection angle α of −30° to +30° with respect to a plane of the target surface; and depositing the heated ceramic feedstock onto the target surface to form the coating thereon, wherein the plasma spray gun and the sacrificial composition injection apparatus are configured to independently control a RE silicate composition and a level of porosity in the coating.

In another aspect, the present disclosure is directed to a method for forming a coating on a target surface of a substrate. The method includes feeding at least one ceramic feedstock into a plasma arc of a plasma spray gun to form a heated ceramic feedstock; entraining the heated ceramic feedstock in a plasma gas stream to form a plasma flame directed toward the target surface of the substrate, the substrate including a ceramic matrix composite (CMC); feeding with a sacrificial composition feed apparatus a sacrificial composition into the plasma flame to at an injection angle α of −30° to +30° with respect to a plane of the target surface to form a composite gas stream; and depositing the heated ceramic feedstock onto the target surface to form an abradable coating thereon, the abradable coating including a first discrete layer rich in a rare-earth (RE) monosilicate and a second discrete layer rich in a RE disilicate, wherein the injection angle α and settings of the plasma spray gun are selected to independently determine a porosity and a chemical composition of at least one of the first discrete layer and the second discrete layer.

In another aspect, the present disclosure is directed to a thermal spray system including a plasma spray gun with an electrode; a feed of a plasma gas to the plasma spray gun; a feed of at least one ceramic feedstock to the plasma spray gun; wherein the feed of the carrier gas and the feed of the at least one ceramic feedstock are controlled to produce a plasma flame directed toward a target surface of a substrate; and a feed system including a feed of a sacrificial composition into the plasma flame, wherein the feed system has an angularly controllable nozzle configured to inject the sacrificial composition into the plasma flame over a range of introduction angles α of −30° to +30° with respect to a plane of the target surface of the substrate; and a controller that provides control signals configured to control at least one of the electrode of the plasma spray gun, the feed of the carrier gas into the plasma spray gun, the feed of the at least one ceramic feedstock into the plasma spray, the feed of the sacrificial composition, or the introduction angle of the angularly controllable nozzle into the plasma flame, such that the plasma flame forms a coating on the target surface with an independently selectable coating composition and coating porosity.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a schematic cross-sectional view of an example embodiment of a thermal spray apparatus suitable for forming an abradable coating on a target surface of a substrate.

FIG. 2 is a flow chart of an example method for making an abradable coating according to the present disclosure.

FIGS. 3A-3I are a collection of photographs of coating samples at 100× magnification made using a thermal spray apparatus similar to that shown in FIG. 1, and according to the parameters set forth in in Table 2. The inset values in each photograph show the porosity of the sample. As shown in Table 2, the coatings in FIGS. 3A, 3D and 3G were made at a sacrificial composition flow rate of 1 g/min, the coatings in FIGS. 3B, 3E and 3H were made at a sacrificial composition flow rate of 2.6 g/min, and the coatings in FIGS. 3C, 3F and 3I were made at a sacrificial composition flow rate of 4.1 g/min.

FIG. 3A is a photograph of the coating made according to the parameters set forth in Run 24 in Table 2.

FIG. 3B is a photograph of the coating according to the parameters set forth in Run 23 in Table 2.

FIG. 3C is a photograph of the coating made according to the parameters set forth in Run 22 in Table 2.

FIG. 3D is a photograph of the coating made according to the parameters set forth in Run 27 in Table 2.

FIG. 3E is a photograph of the coating made according to the parameters set forth in Run 26 in Table 2.

FIG. 3F is a photograph of the coating made according to the parameters set forth in Run 25 in Table 2.

FIG. 3G is a photograph of the coating made according to the parameters set forth in Run 30 in Table 2.

FIG. 3H is a photograph of the coating made according to the parameters set forth in Run 29 in Table 2.

FIG. 3I is a photograph of the coating made according to the parameters set forth in Run 28 in Table 2.

FIG. 3J is a plot comparing the ytterbium monosilicate (YbMS) content vs. porosity for the coatings in FIGS. 3A-3I.

FIGS. 4A-4I are a collection of photographs of coating samples at 500× magnification made using a thermal spray apparatus similar to that shown in FIG. 1, and according to the parameters set forth in in Table 2. The inset values in each photograph show the yttrium monosilicate (YbMS) content of the sample. As shown in Table 2, the coatings in FIGS. 4A, 4D and 4G were made at a sacrificial composition flow rate of 1 g/min, the coatings in FIGS. 4B, 4E and 4H were made at a sacrificial composition flow rate of 2.6 g/min, and the coatings in FIGS. 4C, 4F and 4I were made at a sacrificial composition flow rate of 4.1 g/min.

FIG. 4A is a photograph of the coating made according to the parameters set forth in Run 24 in Table 2.

FIG. 4B is a photograph of the coating made according to the parameters set forth in Run 23 in Table 2.

FIG. 4C is a photograph of the coating made according to the parameters set forth in Run 22 in Table 2.

FIG. 4D is a photograph of the coating made according to the parameters set forth in Run 27 in Table 2.

FIG. 4E is a photograph of the coating made according to the parameters set forth in Run 26 in Table 2.

FIG. 4F is a photograph of the coating made according to the parameters set forth in Run 25 in Table 2.

FIG. 4G is a photograph of the coating made according to the parameters set forth in Run 30 in Table 2.

FIG. 4H is a photograph of the coating made according to the parameters set forth in Run 29 in Table 2.

FIG. 4I is a photograph of the coating made according to the parameters set forth in Run 28 in Table 2.

FIG. 4J is a plot comparing the ytterbium monosilicate (YbMS) content vs. porosity for the coatings in FIGS. 4A-4I.

Like symbols in the drawings indicate like elements.

### DETAILED DESCRIPTION

In a thermal spraying process, a ceramic feedstock is fed into a heating zone to form a heated ceramic feedstock. The heated ceramic feedstock is entrained in a carrier gas to form a heated gas stream directed toward a target surface of a substrate. The heated ceramic feedstock in the heated gas stream is deposited on the target surface to form a coating thereon. Suitable thermal spraying techniques include, but are not limited to, flame spraying, plasma spraying, high velocity oxygen fuel (HVOF) spraying, vacuum plasma spraying, arc metallization, detonation gun spraying, and combinations thereof.

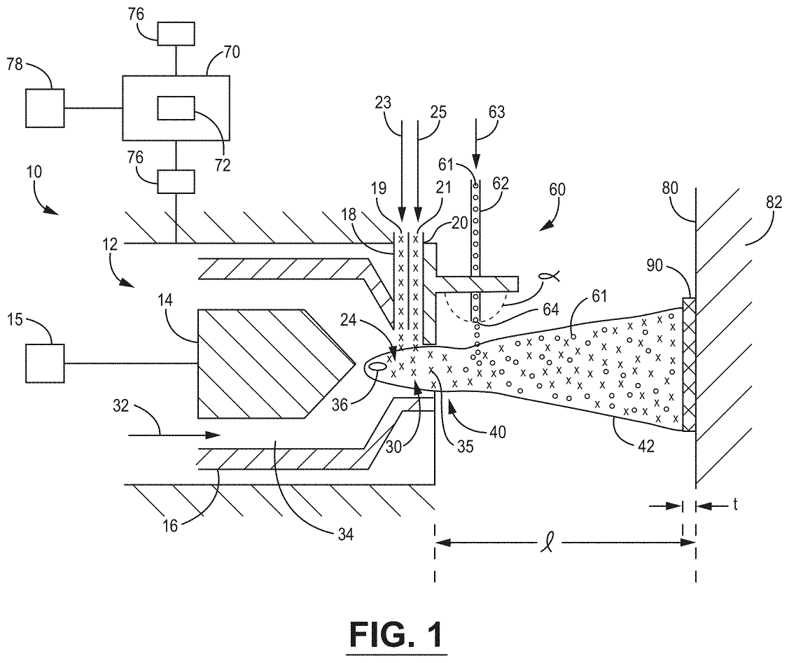

Referring now to FIG. 1, an example of a plasma spray apparatus 10, which is not intended to be limiting, includes a plasma torch or spray gun 12. The plasma spray gun 12 includes a cathode 14 and an anode 16, and is powered by a power supply 15. In the plasma spray gun 12 of FIG. 1, the cathode 14 is cone-shaped, while the anode 16 is substantially cylindrical, but the cathode 14 and the anode 16 may have any suitable shape. Both the anode 14 and the cathode 16 may be made of any suitable metal or metal alloy such as, for example, those including tungsten, copper, iron, aluminum, and the like.

One or more plasma gases 32 for forming a plasma and accelerating a ceramic feedstock toward a target surface of a substrate flow are fed into the plasma spraying apparatus 10 through annular passages 34 in the plasma spray gun 12, and a plasma arc 36 is formed between the electrodes 14, 16. Suitable plasma gases 32 include, but are not limited to, combustible gases such as oxygen and hydrogen, as well as relatively inert gases such as argon, nitrogen, helium, water vapor, and mixtures and combinations thereof.

As shown schematically in FIG. 1, one or more injection ports 18, 20 are used to feed at least one ceramic feedstock 19, 21 into the plasma spray gun 12. In another example (not shown in FIG. 1), the ceramic feedstock 19, 21 can be input into the plasma spray gun 12 axially so that the ceramic feedstock can be entrained in the plasma gas 32. In some examples, the ceramic feedstock 19, 21 is transported into the plasma spray apparatus by a carrier gas 23, 25. The carrier gas 23, 25 used to feed the ceramic feedstock include but not limited to inert gases such as argon, nitrogen, helium, and mixtures and combinations thereof. The ceramic feedstocks 19, 21 enter a heating zone 30 between the two electrodes 14, 16 and adjacent to the plasma arc 36 to form a heated ceramic feedstock 24 in the heating zone 30. In various examples, the one or more ceramic feedstocks 19, 21 may be fed into the plasma spray apparatus 10 in the form of a powder, a rod, a wire, a slurry, a liquid, or combinations thereof. In some examples, the composition of the ceramic feedstocks 19, 21 can be selected to combine in the heating zone 30 to produce a coating 90 on a target surface 80 of a substrate 82 with a selected composition, a selected layer structure, and the like.

In some cases, other parameters of the plasma spray apparatus 10 and the plasma spray gun 12 may be adjusted to produce a selected composition for the coating 90 such as, for example, the flow rate of the plasma gas 32, the current between the electrodes 14, 16, a path length/from a nozzle 40 to the target surface 80, and the like. In some examples, which are not intended to be limiting, parameters of the plasma spray apparatus 10 such as the current between the electrodes 14, 16 and the path length/may be selected to control the amount of Si consumed during the flight of the plasma from the nozzle 40 to the target surface 80, which can have an impact on the ratio of RE disilicate to RE monosilicate in the deposited coating.

In other examples, the ceramic feedstocks 19, 21 may be fed into the heating zone 30 in a form selected to provide a particular composition or microstructure in the coating 90. In one example, which is not intended to be limiting, the ceramic feedstocks 19, 21 are fed into the heating zone 30 as fine particles 35 with a particle size of about 5 μm to about 100 μm, or about 20 μm to about 80 μm, or about 22 μm to about 70 μm. In some examples, powders 35 with a relatively narrow size distribution can be used to achieve uniform heating in the heating zone 30 and acceleration into the stream of the carrier gas 32. In some examples, a substantially constant powder feeding rate can provide the coating 90 with a more uniform thickness t and improve coating quality. The shape of the fine particles of the ceramic feedstocks 19, 21 may vary widely, but generally spherical particles have been found to provide good flow properties, which can provide a good microstructure for the coating 90, but other shapes are possible such as, for example, angularly shaped particles.

The heated ceramic feedstock 24 is entrained in the stream of the carrier gas 32 that flows into the heating zone 30 so that the plasma arc 36 loops out of the nozzle 40 of the plasma gun 12 and forms a heated gas stream also referred to herein as a plasma flame 42. In some examples, the temperatures in a plasma flame 42 can be about 10,000° C. to about 15,000° C., which in various examples can melt all or a portion of the heated ceramic feedstock 24.

Depending on the settings selected for the plasma spray apparatus 10 and the plasma gun 12, the properties of the plasma flame 42 can be adjusted so that all or a portion of the heated ceramic feedstock 24 can include ceramic particles 35 that are softened, partially molten, or fully melted into droplets. In some examples, the extremely high temperatures in the plasma flame 42 melt at least about 20% to about 90% of the ceramic particles 35 into droplets.

The at least partially melted or softened ceramic particles 35 arrive on the surface 80 after having been sufficiently heated and accelerated by the plasma flame 42. The velocity and temperature of the ceramic particles or droplets 35 are directly related to, for example, the plasma gas type, parameters of the plasma gun 12, distance between the plasma gun 12 and the surface 80. When the softened ceramic materials, which in some cases are in the form of droplets, impact the surface 80, they are flattened and spread out on the surface 80 and form a coating through successive impingement. In some examples, the ceramic particles 35 are deposited to form a substantially continuous coating 90, and in other examples the ceramic particles 35 are deposited in discontinuous regions referred to as “splats” to form the coating 90.

Upon impact, the ceramic particles 35 in the plasma flame 42 cool down and rapidly solidify on the target surface 80 by heat transfer to the underlying substrate 82 and form, by accumulation, the lamellar coating 90.

The plasma spray apparatus 10 and the plasma spray gun 12 further include a feed system 60 for feeding a sacrificial composition 61 into the plasma flame 42. The feed system 60 includes an injection port 62, and in various examples the sacrificial composition 61 can be fed into the plasma flame 42 via an angularly adjustable nozzle 64 by gravity, by extrusion, with a plunger, or by entraining particles of the sacrificial composition in a carrier gas 63, which may be the same or different from the plasma gas 32 used to entrain the ceramic particles and form the plasma flame, and the carrier gases 23, 25 utilized to transport the ceramic particles 19, 21. In various examples, the sacrificial composition 61 may fed into the plasma flame 42 in the form of particles, droplets, a liquid, as a slurry, or combinations thereof.

The flow rate of the carrier gas, the feed rate of the sacrificial composition 61, or both, can be adjusted to disrupt the flow of the ceramic particles 35 in the plasma flame 42 in different ways. In some examples, a larger powder feed rate or carrier gas flow rate feeds a larger quantity of sacrificial material into the plasma flame 42, which can increase the porosity of the coating 90 or a selected layer or region thereof.

In some examples, the angle α of the nozzle 64 may also be adjusted through a range of 0° to 90°, or −30° (backward) to +30° (forward), or −15° (backward) to +15° (forward), with respect to a plane of the target surface 80, to introduce the sacrificial composition 61 into the plasma flame 42 in a wide variety of different ways. For example, a small injection angle α would be expected to cause a different type of turbulence in the plasma flame 42 relative to a large injection angle α, but any suitable injection angle may be selected to modify the in-flight behavior of the heated ceramic particles 35 in the plasma flame 42 during a travel time over the path length t to the surface 80 and produce a desired porosity in the coating 90.

In some examples, physical properties of the particles of the sacrificial composition 61 such as particle shape and size, are selected to modify the in-flight behavior of the ceramic particles 35 in the plasma flame 42. In one example, the sacrificial composition 61 is fed into the plasma flame 42 as fine particles with a particle size of about 5 μm to about 150 μm, or about 45 μm to about 125 μm.

In some examples, the sacrificial composition 61 enters the plasma flame 42 as generally spherical particles, but other shapes are possible such as, for example, angularly shaped particles. In some examples, larger particles or droplets can survive for longer periods of time in the plasma flame 42, and maintain separation between the heated ceramic particles 35 during the travel time toward the surface 80. In some examples, this separation between the particles in on the target surface 80 can provide a coating 90 or a layer thereof with a greater porosity.

In some examples, the particles or droplets of the sacrificial composition 61 may have a chemical composition selected such that the particles or droplets are completely or partially vaporized in the high-temperature plasma flame 42 during the travel time of the ceramic particles 35 toward the target surface 80. For example, the sacrificial composition may be chosen from polymeric materials, which in one non-limiting example include polyesters. In some examples, the chemical composition can be selected such that the particles or droplets of the sacrificial composition 61 survive in the plasma flame 42 for a longer period of time before volatilization occurs. In some examples, the enhanced physical interaction between the longer-lived particles of the sacrificial composition 61 and the ceramic particles in the plasma flame can provide a coating 90 or a layer there of with greater porosity.

In some examples, the chemical composition of the particles or droplets of the sacrificial composition 61 may be selected such that the coating 90, or a portion or layer thereof, includes the sacrificial composition. In some cases, the chemical composition of the sacrificial composition may be selected to chemically react or physically interact with the ceramic particles in the coating 90, which can impact the composition or the porosity of the coating 90. In some cases, the chemical composition of the sacrificial composition may be selected to remain between the ceramic particles in the coating 90. In some examples, the particles of the sacrificial composition remaining in the coating 90 may form a permanent part of the coating 90, or may be removed from the coating 90 in a subsequent processing step by heating, chemical treatment, and combinations thereof.

In some examples, the plasma sprayed coating 90 is formed by the build-up of successive layers of ceramic particle droplets 35 flattened upon impact on the surface 80, and hence the coating 90 has a substantially continuous or substantially discontinuous layered structure.

In various examples shown schematically in FIG. 1, the plasma spray apparatus 10 may include a controller 70 with at least one processor 72. The controller 70 may be configured to control one or more parameters of the plasma spray apparatus 10 to determine one or more physical or chemical properties of the plasma flame 42 and the coating 90 produced therefrom. In some examples, which are not intended to be limiting, the controller 70 may be configured to control the power supply 15 of the plasma spray gun 10 to adjust one or more of the arc created by the electrodes 12, 14. In another example, the controller 70 may be configured to adjust the flow rates of the plasma gas 32, the carrier gases 23, 25 for the ceramic powders 19, 21, and the carrier gas 63 for the sacrificial composition 61, feed rates of the ceramic feedstocks 19, 21, the feed rate of the sacrificial composition 61, and the feed angle α of the nozzle 64.

In some examples, the controller 70 may be configured to process detected signals from one or more sensor systems 74 in or on the plasma spray apparatus 10. The processor 72 may be integrated with the sensor systems 74, may be integrated with the controller 70, or may be a remote processor functionally connected to the controller 70.

The processor 72 may be any suitable software, firmware, hardware, or combination thereof. The processor 72 may include any one or more microprocessors, controllers, digital signal processors (DSPs), application specific integrated circuits (ASICs), field-programmable gate arrays (FPGAs), or discrete logic circuitry. The functions attributed to the processor 72 may be provided by processing circuitry of a hardware device, e.g., as supported by software and/or firmware.

In some examples, the processor 72 may be coupled to a memory device 76, which may be part of the controller 70 or remote thereto. The memory device 76 may include any volatile or non-volatile media, such as a random-access memory (RAM), read only memory (ROM), non-volatile RAM (NVRAM), electrically erasable programmable ROM (EEPROM), flash memory, and the like. The memory device 76 may be a storage device or other non-transitory medium. The memory device 76 may be used by the processor 72 to, for example, store fiducial information or initialization information corresponding to, for example, measurements or stored signals from the sensor system 74 of parameters of the plasma spray apparatus 10, the plasma flame 42, and the coating 90. In some examples, which are not intended to be limiting, the memory device 76 may store information regarding one or more of the arc created by the electrodes 12, 14, the flow rate of the plasma gas 32, the flow rates of the carrier gases 23, 25, 63, the feed rates of the ceramic feedstocks 19, 21, the feed rate of the sacrificial composition 61, the feed angle α of the nozzle 64, and the like, for later retrieval. In some examples, the memory device 76 may store determined values, such as information corresponding to detected layer thickness measurements and layer thickness compositions for the coating 90, for later retrieval.

In some embodiments, the controller 70 and the processor 72 are coupled a user interface 78, which may include a display, user input, and output (not shown in FIG. 1). Suitable display devices include, for example, monitor, PDA, mobile phone, tablet computers, and the like. In some examples, user input may include components for interaction with a user, such as a keypad and a display such as a cathode ray tube (CRT) display, a liquid crystal display (LCD) or light emitting diode (LED) display, and the keypad may take the form of an alphanumeric keypad or a reduced set of keys associated with particular functions. In some examples, the displays may include a touch screen display, and a user may interact with user input via the touch screens of the displays. In some examples, the user may also interact with the user input remotely via a networked computing device.

The controller 70 can be configured to control any selected number of functions of the plasma spray apparatus 10 including, but not limited to, one or more of the arc created by the electrodes 12, 14, the feed rate of the plasma gas 32, the carrier gases 23, 25, 63, the feed rates of the ceramic feedstocks 19, 21, the feed rate of the sacrificial composition 61, and the feed angle α of the nozzle 64 in response to signals from the processor 72 input manually into the controller 70, or stored in the memory device 76.

In some examples, the controller 70 can be configured to generate control signals, based in part on layer thickness information or layer composition information regarding the coating 90 and obtained from, for example, one or more sensors in the sensor system 74, to provide closed loop control of the layer composition of the coating 90 produced by the plasma flame 42.

In various examples, the controller 70 may be adjusted by a variety of manual and automatic means. Automatic means may make use of any number of control algorithms or other strategies to achieve desired conformance to a control parameter or desired layer thickness function for the coating 90. For example, standard control schemes as well as adaptive algorithms such as so-called “machine-learning” algorithms may be used. In some examples, controller 70 can utilize information from other sources such as, for example, infrared cameras, to determine the control action decided by algorithms such as PID control schemes or machine learning schemes.

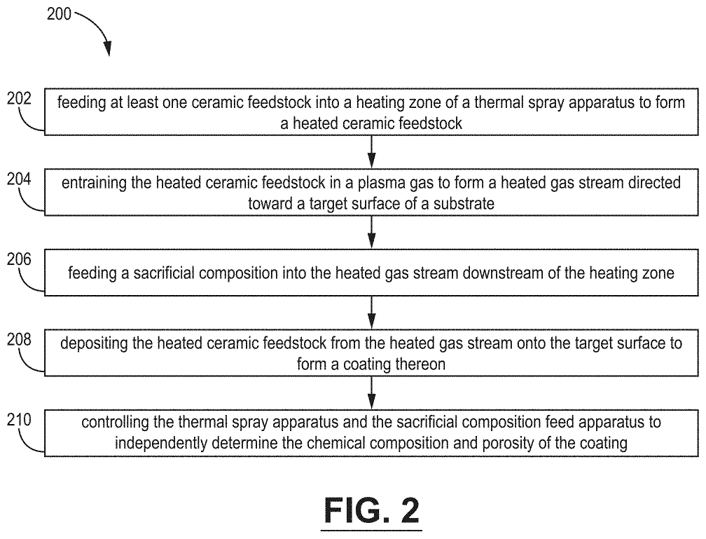

Referring now to FIG. 2, in an example a method 200 includes in step 202 feeding at least one ceramic feedstock into a heating zone of a thermal spray apparatus to form a heated ceramic feedstock.

In step 204, the method 200 includes entraining the heated ceramic feedstock in a plasma gas to form a heated gas stream directed toward a target surface of a substrate to control a RE silicate content of a coating formed on the target surface.

In step 206, the method 200 includes injecting with a sacrificial composition feed apparatus a sacrificial composition into the heated gas stream downstream of the heating zone to control the porosity of the coating on the target surface.

In step 208, the method further includes depositing the heated ceramic feedstock from the heated gas stream onto the target surface to form a coating thereon.

In step 210, the thermal spray apparatus and the sacrificial composition feed apparatus are controlled to independently determine a chemical composition and a porosity of the deposited coating.

As described above, a thermal spray process utilizing the plasma spray gun 12 of FIG. 1 may be used to coat a target surface 80 of any type of substrate 82 suitable for use in a high-temperature environment. In some examples, the substrate 82 may include a ceramic or a ceramic matrix composite (CMC). Suitable ceramic materials, may include, for example, a silicon-containing ceramic, such as silica (SiO₂) and/or silicon carbide (SiC); silicon nitride (Si₃N₄); alumina (Al₂O₃); an aluminosilicate; a transition metal carbide (e.g., WC, Mo₂C, TiC); a silicide (e.g., MoSi₂, NbSi₂, TiSi₂); combinations thereof; or the like. In some examples in which substrate 82 includes a ceramic, the ceramic may be substantially homogeneous.

The system and process of the present disclosure has been found to be particularly well suited for applying one or more barrier layers on ceramic matrix composite (CMC) substrates to form a coating 90 that provides protection against thermal flux, erosion, and/or environmental contamination, for example, by reducing or preventing CMAS formation, migration, or infiltration. In some examples, environmental barrier coatings (EBCs) may be employed to protect Si-containing substrates such as SiC/SiC CMCs from water vapor attack. Rare earth silicates such as ytterbium disilicate (YbDS) have been used in EBCs for SiC based CMCs. Among other desirable attributes, YbDS has a good match of coefficient-of-thermal-expansion (CTE) with CMC.

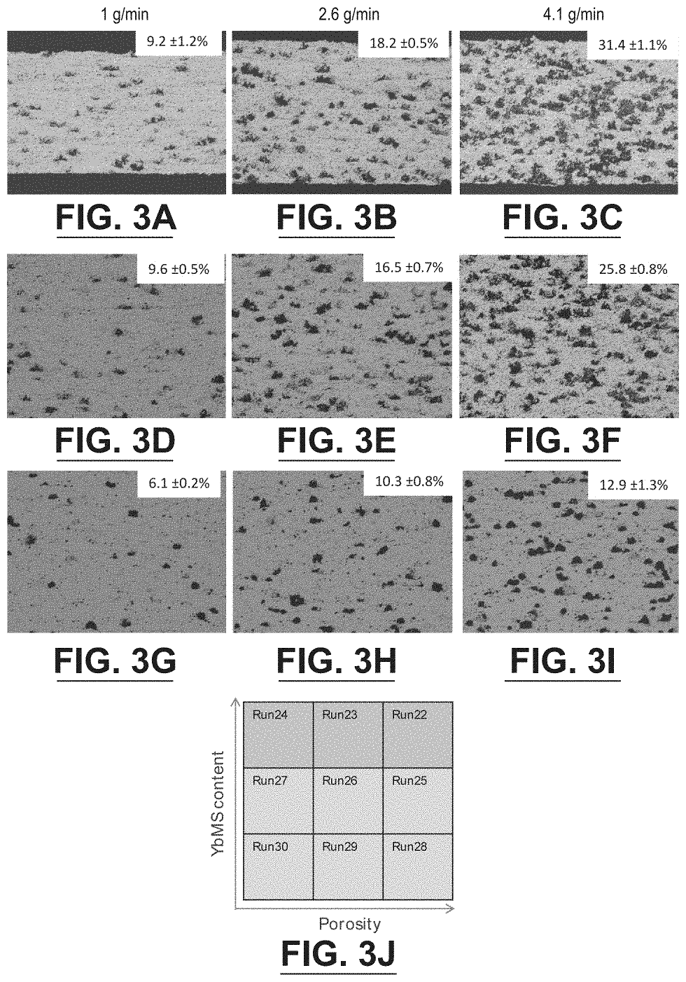

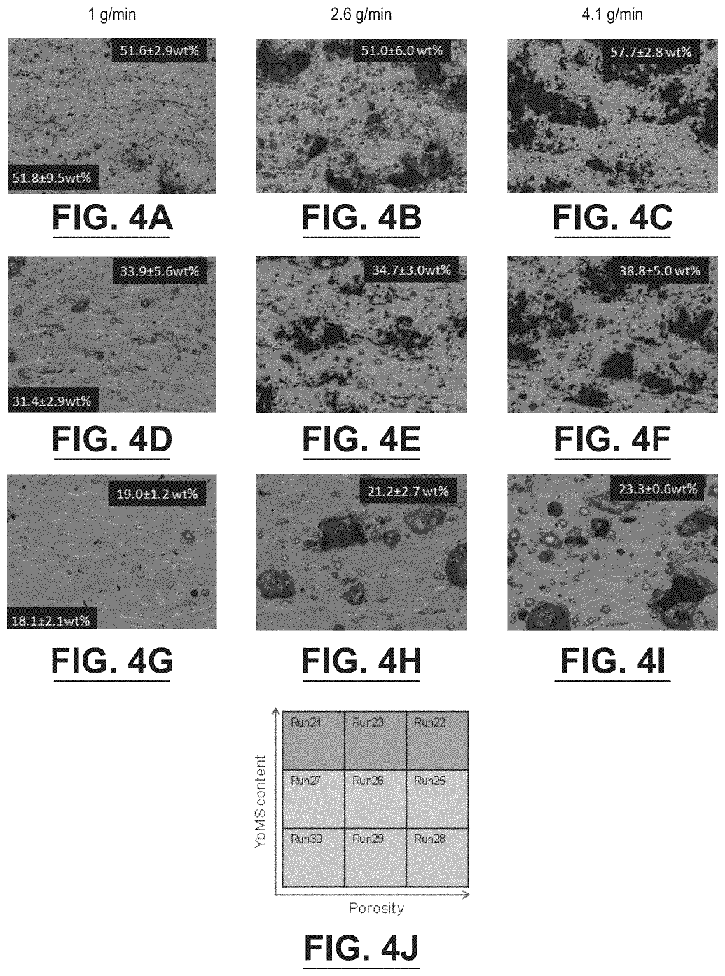

In some examples, the parameters of thermal spray apparatus 10 shown schematically in FIG. 1 may be used to independently control the porosity and RE silicate content of an abradable coating. In some examples (see, for example, FIGS. 3A-I and FIGS. 4A-I discussed in the examples below), which are not intended to be limiting, the abradable coatings can have an RE monosilicate content of about 15 wt % to about 60 wt % and a porosity of about 5% to about 35%.

In some examples, the thermal spray apparatus 10 may be used to independently control the porosity and RE silicate content of a layered abradable coating, each layer having a predetermined RE monosilicate or RE disilicate content and a predetermined porosity. In some examples, which are not intended to be limiting, the graded abradable coatings can include a plurality of sublayers with graded RE monosilicate content, each having a predetermined porosity.

The invention will now be further described with reference to the following non-limiting examples.

### EXAMPLES

A plasma spray gun available under the trade designation SG-100 from Praxair Surface Technologies, Indianapolis, Ind., included an angularly variable powder feed apparatus as shown in FIG. 1 for feeding a sacrificial material into the plasma flame over a selected injection angle α. The plasma spray gun was used to thermally spray ceramic abradable coatings.

As shown in detail in Table 1 below, various parameters of the plasma spray gun (for example, gun current and plasma gas flow rate) were controlled to determine their impact on the RE silicate content of the sprayed coatings. Various parameters of the sacrificial feed apparatus (for example, flow rate of the carrier gas supplying the sacrificial composition and mass flow rate of the sacrificial composition) were varied to control the RE silicate content and the porosity of the sprayed coatings, independent of the RE silicate content.

The ceramic material used in this example was ytterbium disilicate (YbDS), which was supplied at a mass flow rate of 40 grams/minute with a plasma gas flow rate varying from 2.2 nL/min to 4.2 nL/min. The standoff distance between the nozzle of the plasma spray gun and the target surface was 4 inches (10 cm).

The sacrificial composition used in this example was a polyester powder, which was injected into the plasma flame by an inert carrier gas.

As noted by the plot accompanying Table 1, the ytterbium monosilicate (YbMS) content of the coating produced by the plasma spraying process in this example gradually increased along the y-axis from runs 28-30 to runs 25-27 to runs 22-24, while the porosity increased along the x-axis from run 30 to run 28, from run 27 to run 25, and from run 24 to run 22.

FIGS. 3A-3I are photographs showing the porosity evaluation of the samples of Table 1 at a magnification of 100×.

FIGS. 4A-4I are photographs showing the ytterbium monosilicate (YbMS) evaluation of the samples of Table 1 at a magnification of 500×.

The results in FIGS. 3A-I and 4A-I indicate that the RE silicate content and porosity of a coating can be tuned independently. For example, referring to Table 1, the ytterbium monosilicate (YbMS) content can be controlled by adjusting the parameters of the plasma spray gun, while the porosity of the coating can be controlled by adjusting at least one of the feed rate, injection angle and carrier gas flow for the polyester powder. The results in FIGS. 3-4 also indicate that the process control made possible by the apparatus of FIG. 1 and the processes described herein can enable the fabrication of coatings with a graded abradable architecture.

### Examples

A. A method for forming a coating on a target surface of a substrate, the method comprising:

feeding at least one ceramic feedstock into a plasma arc of a plasma spray gun to form a heated ceramic feedstock;

entraining the heated ceramic feedstock in a plasma gas stream to form a plasma flame directed toward the target surface of the substrate, the substrate comprising a ceramic matrix composite (CMC);

feeding with a sacrificial composition feed apparatus a sacrificial composition into the plasma flame to at an injection angle α of −30° to +30° with respect to a plane of the target surface to form a composite gas stream; and

depositing the heated ceramic feedstock onto the target surface to form an abradable coating thereon, the abradable coating comprising a first discrete layer rich in a rare-earth (RE) monosilicate and a second discrete layer rich in a RE disilicate, wherein the injection angle α and settings of the plasma spray gun are selected to independently determine a porosity and a chemical composition of at least one of the first discrete layer and the second discrete layer.

B. The method of example A, wherein the RE disilicate comprises ytterbium disilicate (YbDS), and the RE monosilicate comprises ytterbium monosilicate (YbMS).
C. A thermal spray system, comprising:

a plasma spray gun comprising an electrode;

a feed of a plasma gas to the plasma spray gun;

a feed of at least one ceramic feedstock to the plasma spray gun;

wherein the feed of the carrier gas and the feed of the at least one ceramic feedstock are controlled to produce a plasma flame directed toward a target surface of a substrate; and

a feed system comprising a feed of a sacrificial composition into the plasma flame, wherein the feed system comprises an angularly controllable nozzle configured to inject the sacrificial composition into the plasma flame over a range of introduction angles α of −30° to +30° with respect to a plane of the target surface of the substrate; and

a controller that provides control signals configured to control at least one of the electrode of the plasma spray gun, the feed of the carrier gas into the plasma spray gun, the feed of the at least one ceramic feedstock into the plasma spray, the feed of the sacrificial composition, or the introduction angle of the angularly controllable nozzle into the plasma flame, such that the plasma flame forms a coating on the target surface with an independently selectable coating composition and coating porosity.

D. The thermal spray system of Example C, wherein the controller provides continuous feedback to at least one of the power supply of the plasma spray gun, the feed of the plasma gas into the plasma spray gun, the feed of the at least one ceramic feedstock into the plasma spray, the feed of the sacrificial composition, or the introduction angle α of the angularly controllable nozzle into the plasma flame, to maintain the coating composition and coating porosity.

Various examples have been described. These and other examples are within the scope of the following claims.

What is claimed is:

1. A method, comprising:
feeding at least one ceramic feedstock into a heating zone of a thermal spray apparatus to form a heated ceramic feedstock;
entraining the heated ceramic feedstock in a plasma gas to form a heated gas stream directed toward a target surface of a substrate, the substrate comprising a ceramic matrix composite (CMC);
feeding a sacrificial composition with a sacrificial composition feed apparatus into the heated gas stream downstream of the heating zone, wherein the sacrificial composition is fed into the heated gas stream at a selected injection angle α of about −30° to about +30° with respect to a plane of the target surface of the substrate; and
depositing the heated ceramic feedstock from the heated gas stream onto the target surface to form a coating thereon, wherein the thermal spray apparatus and the sacrificial composition feed system are configured to independently control a chemistry and a porosity of the coating.

2. The method of claim 1, wherein the ceramic feedstock comprises at least one rare earth (RE) silicate.

3. The method of claim 1, wherein the ceramic feedstock comprises a first feed comprising a rare earth (RE) monosilicate and a second feed comprising a RE disilicate.

4. The method of claim 1, wherein the injection angle α is −15°.

5. The method of claim 1, wherein the sacrificial composition comprises a polymeric powder entrained in a gas stream.

6. The method of claim 1, wherein the coating is substantially free of the sacrificial composition.

7. The method of claim 1, further comprising treating the coating to remove at least a portion of the sacrificial composition.

8. A thermal spray apparatus, the apparatus comprising:
a spray gun, comprising:
at least one injection port configured to feed a ceramic feedstock into a heating zone, wherein the ceramic feedstock is heated in the heating zone to form a heated ceramic feedstock, and
at least one plasma gas supplied to entrain the heated ceramic feedstock and provide a heated gas stream downstream of the heating zone, wherein the heated gas stream is directed toward a target surface of a substrate; and
a sacrificial composition feed apparatus between the heating zone of the spray gun and the target surface, wherein the sacrificial composition feed apparatus comprises an adjustable nozzle configured to feed a sacrificial composition into the heated gas stream at an injection angle α of −30° to +30° with respect to a plane of the target surface of the substrate, wherein the spray gun and the sacrificial composition feed apparatus are configured to provide independent control of a chemistry and a porosity of a coating formed on the target surface of the substrate.

9. The thermal spray apparatus of claim 8, wherein the injection angle α is −15°.

10. The thermal spray apparatus of claim 8, wherein the spray gun comprises a first injection port configured to feed a first ceramic material into the heating zone, and a second injection port configured to feed a second ceramic material into the heating zone, wherein the first ceramic material is different from the second ceramic material.

11. The thermal spray apparatus of claim 10, further comprising a first rare earth (RE) silicate in the first injection port and a second RE silicate in the second injection port, wherein the first RE silicate is different from the second RE silicate.

12. The thermal spray apparatus of claim 8, wherein the sacrificial composition is entrained in a carrier gas stream, and wherein the sacrificial composition comprises a polymeric material.

13. The thermal spray apparatus of claim 8, wherein a plasma is formed in the heating zone.

14. The thermal spray apparatus of claim 8, wherein the injection port is configured to feed the ceramic material into the heating zone in the form of a powder.

15. The thermal spray apparatus of claim 8, wherein the heating zone is configured to at provide an at least partially molten ceramic feedstock in the heated gas stream.

16. The thermal spray apparatus of claim 8, wherein the target surface comprises a ceramic matrix composite (CMC).

17. A method for forming a coating on a target surface of a substrate comprising a ceramic matrix composite (CMC), the method comprising:
entraining a heated ceramic feedstock in a plasma gas stream in a plasma spray gun to form a plasma flame directed toward the target surface, wherein the ceramic feedstock comprises a rare earth (RE) silicate;
feeding with a sacrificial composition injection apparatus a sacrificial polymeric composition into the plasma flame at an injection angle α of −30° to +30° with respect to a plane of the target surface; and
depositing the heated ceramic feedstock onto the target surface to form the coating thereon, wherein the plasma spray gun and the sacrificial composition injection apparatus are configured to independently control a RE silicate composition and a level of porosity in the coating.

18. The method of claim 17, wherein the heated ceramic feedstock is at least partially molten.

19. The method of claim 17, wherein at least one ceramic feedstock comprises a first ceramic feedstock comprising a rare earth (RE) monosilicate and a second ceramic feedstock comprising a RE disilicate.

20. The method of claim 17, wherein the sacrificial polymeric composition is fed into the plasma flame in the form of a powder entrained in a carrier gas.
